(19) United States
(12) Patent Application Publication
(10) Pub. No.: US 2016/0375982 A1
(43) Pub. Date: Dec. 29, 2016

(54) SYSTEM AND METHODS ASSOCIATED WITH A RIDEABLE MULTICOPTER

(71) Applicant: WILLIAM McKENZIE RIFENBURGH, HOUSTON, TX (US)

(72) Inventor: WILLIAM McKENZIE RIFENBURGH, HOUSTON, TX (US)

(21) Appl. No.: 15/174,959

(22) Filed: Jun. 6, 2016

Related U.S. Application Data
(60) Provisional application No. 62/184,837, filed on Jun. 25, 2015.

(51) Int. Cl. B64C 13/04; B64C 27/56

(52) U.S. Cl. CPC B64C 13/04; B64C 27/56; B64D 27/02

(57) ABSTRACT

Embodiments described herein relate to multicopters with separate engines to power each rotor, wherein the multicopters also include with unique controls to guide the multicopter.

### CROSS-REFERENCE TO RELATED APPLICATIONS

This application claims a benefit of priority under 35 U.S.C. §119 to Provisional Application No. 62/184,837 filed on Jun. 25, 2015, which is fully incorporated by reference in its entirety.

### TECHNICAL FIELD

Embodiments disclose systems and methods associated with a rideable multicopter. Specifically, embodiments are directed towards a multicopter with separate engines to rotate corresponding propellers, wherein the multicopter includes with unique controls to guide the multicopter.

### BACKGROUND

Multicopters are devices that are lifted and propelled by vertically oriented propellers. By varying the speed at which each propeller rotates, the multicopter may be controlled. Some experimental multicopters are comprised of two propellers to create the lift and use thrust vectoring to steer the vehicle.

However, said experimental multicopters are typically unstable. Furthermore, multicopters that use electrical motors may be light, but they require a large battery. Current battery technology only allows multicopters to fly for a limited amount of time.

Additionally, controls for conventional multicopters involve the use of two joysticks. The first joystick may control movement along a horizontal plane, and the second joystick may control altitude thrust and yawing. Yet, it is an arduous task to yaw on a single joystick without affecting altitude.

Accordingly, needs exist for a multicopter with independent, combustion engine powered rotors with a control interface that separates yawing and altitude control.

### SUMMARY

Embodiments described herein relate to multicopters with separate engines to power each propeller, wherein the multicopters also include with unique controls to guide the multicopter. Embodiments of a multicopter utilize combustion engines, which will allow the multicopter to take advantage of the higher energy density of fossil fuels to have a much longer flight time. Additionally, each propeller of the multicopter may have a mechanically independent engine. This may allow the multicopter to maintain altitude control and perform user controlled emergency descents in the event of a single engine failure.

Embodiments may also utilize a control interface that includes a first joystick to control horizontal plane movement, a second joystick to control altitudinal movement and braking, and a handle bar steering column to control yawing.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention. The invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a perspective view of a multicopter, according to an embodiment.

FIG. 2 depicts a top view of a multicopter, according to an embodiment.

FIG. 3 depicts a side view of a multicopter, according to an embodiment.

FIG. 4 depicts a front view of a control interface, according to an embodiment.

FIG. 5 depicts a perspective view of a handle bar, according to an embodiment.

FIG. 6 depicts a network topology of the computing systems of a multicopter, according to an embodiment.

FIG. 7 depicts a propeller unit, according to an embodiment.

FIG. 8 illustrates a method for a multicopter performing a braking operation or decelerating utilizing a position tracking system, according to an embodiment.

FIG. 9 illustrates a method for a controlling a multicopter, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

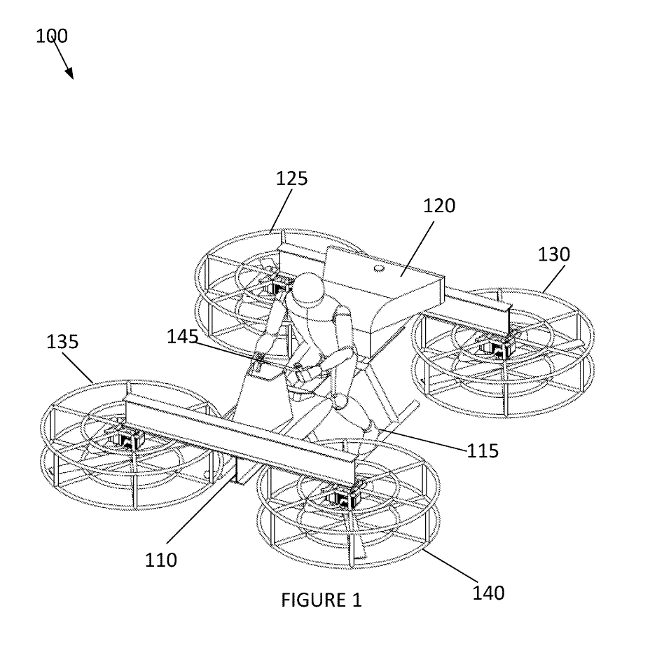

FIG. 1 depicts a perspective view of multicopter 100, according to an embodiment. Multicopter 100 may include a frame 110, landing rails 115, gas tank 120, first propeller unit 125, second propeller unit 130, third propeller unit 135, fourth propeller unit 140, and control interface 145.

Frame 110 may be a structural system that supports other components of multicopter 100. Frame 110 may be comprised of a first beam that extends along a major axis of multicopter 110, and second and third beams that extend along a minor axis of multicopter 110. The beams may be assembled into an “H” shape.

The first beam may have a longer length than the second and third beams, and be positioned perpendicular to the second and third beams. In use, a pilot of multicopter 110 may be positioned over first beam 110.

The second beam may be positioned at a distal end of the first beam, and the third beam may be positioned at a proximal end of the first beam, wherein the second beam and the third beam are in parallel to each other. The lower surfaces of second and third beams may be positioned above upper surfaces of the propeller units 125, 130, 135, 140. In embodiments, the ends of the second beam may be positioned over centers of propeller units 125 and 130, and the ends of the third beam may be positioned over centers of propeller units 135 and 140.

Landing rails 115 may be landing gear that is utilized to stabilize multicopter 100 during takeoff and landing. Additionally, landing rails may support a pilot's feet while in use. Landing rails 115 may be tubular landing skids that are positioned lower than the bottom of other elements of multicopter 100. In embodiments, a distal end of landing rails 115 may be positioned underneath propeller units 125 and 130, and a proximal end of landing rails 115 may be positioned underneath propeller units 135 and 140.

Gas tank 120 may be a device that is a safe container for flammable fluids. Fuel stored within gas tank 120 may be utilized to power propeller units 125, 130, 135, and 140. In embodiments, gas tank 120 may be positioned behind a pilot. However, gas tank 120 may be positioned at any desired location within or on multicopter 100.

Propeller units 125, 130, 135, 140 may each be engine subsystems configured to move multicopter 100. Each propeller unit 125, 130, 135, and 140 may include an engine, a propeller, a tachometer, a protection cage, and a position controlled motor.

Each engine may be a combustion engine that is configured to generate mechanical power by combustion of fuel. Each engine may be configured to independently receive fuel from gas tank 120 via a fuel line. Additionally, each engine may be configured to independently power a corresponding propeller. Therefore, in the event of a single engine failure for a propeller unit, the engines of the other propeller units may still function.

Each propeller may be a type of fan that transmits power by converting a rotational motion into thrust. A pressure difference is produced between the upper and lower surfaces of the propeller. In embodiments, each of the propellers may be configured to rotate around a fixed axis, which may be positioned under an end of second or third beams. The fixed axis of rotation for each propeller may allow the propellers to a have a direction of rotation that is in parallel with a ground surface when multicopter 100 is positioned on a flat, planar surface.

Furthermore, propellers positioned diagonally across from each other may rotate in the same direction, while adjacent propellers may rotate in the opposite direction. For example, propeller units 125 and 135 may rotate in a clockwise direction, while propeller units 130 and 140 may rotate in a counter clockwise direction. A first pair of propeller units 125 and 135 and a second pair of propeller units 130 and 140 may operate together to exert a net yaw torque as desired.

The tachometers may be an instrument configured to measure the rotation speed of a corresponding propeller. The tachometers may be configured to measure the rotation speed of the propellers in revolutions per interval of time.

The protection cages may be configured to encompass the propellers to protect the propellers and exterior objects from the propellers. The protection cages may be comprised of a tube frame that allows the propellers to move air, while limiting objects coming in direct contact with the propellers.

The position controlled electronic motors are configured to control the throttle of its corresponding propeller engine. In embodiments, the position controlled motors may be controlled by a control computer utilizing a position feedback loop via an electronic motor position encoder. The position encoder may communicate position data associated with a throttle position of a propeller engine to a processor linked with the position control motor. The tachometer will transmit propeller engine speed data to the computer. The computer may analyze the throttle position data and the tachometer data to determine an appropriate desired throttle position to command each electronic motor with and dynamically change the rotation rate of the corresponding propeller engine to achieve a desired propeller speed

Control interface 145 may be a device configured to control the positioning of multicopter 100 based on receiving commands from a pilot. Control interface 145 may include a computer.

The computer may be configured to transmit real-time commands to the individual engine subsystems, and receive real-time data from the individual engine subsystems and the control interface 145. In embodiments, the commands may be based on a control algorithm to determine a desired rotational speed of each propeller. The control algorithm may be a closed feedback loop that is based on orientation data and acceleration data from the inertial measurement unit.

The control interface may be configured to allow the pilot to control the yaw, pitch forward and back (i.e. accelerate forward and backward), roll left and right (i.e. accelerate left and right), and ascend and descend. In embodiments, the control interface may include a steering column and two handle bars.

The steering column may be positioned between the two handle bars, and the steering column may be configured to turn axially. Responsive to the steering column being turned, the steering column may transmit yaw command data to the computer. The steering column yaw data may indicate a desired magnitude of the yawing angular velocity of the vehicle that is proportional the angle offset of the handlebars. The steering column may be coupled to an electric motor, wherein the motor is configured to constantly center the steering column in a straight, upright position with slight torque. This upright position may indicate a zero offset of the steering column. This slight torque received by the steering column from the electric motor may provide the pilot with a haptic sensation that is the equivalent of that of a virtual torsional spring on the steering column so that the handle bars return to the zero offset in the event the pilot disengages with the handle bars.

The handle bars may be configured to receive the arms of the pilot and receive force from the pilot. Responsive to the pilot applying force to the handle bars the steering column may turn. Additionally, the two handle bars may each include a two axis thumb stick and a trigger.

A first handle bar may be configured to control horizontal plane motion. Responsive to the thumb stick on the first handle bar being moved or the trigger being pressed, corresponding acceleration command data may be transmitted to the computer. In embodiment, the first handle bar may be the right handle bar or the left handle bar.

In embodiments, the transmitted acceleration command data may correspond to an angle or direction at which the thumb stick is pressed, and the transmitted acceleration command data may also be proportional to the angle at which the thumb stick is pressed. For example, when a first thumb stick is moved forward or backward, fine forward acceleration or fine backward acceleration command data may be transmitted to the computer, respectively. Furthermore, when the first thumb stick is fully pressed forward, the acceleration data may correspond with a greater forward acceleration rate than a partially forward pressed first thumb stick.

Additionally, when the first thumb stick is moved left or right, fine strafe left acceleration command data or fine strafe right acceleration command data may be transmitted to the computer, respectively. Fine strafe acceleration data may be configured to provide limited sideways acceleration to the multicopter 100.

Responsive to the trigger on the first handle bar being pressed, acceleration command data corresponding to a forward motion may be transmitted to the computer. In embodiments, the acceleration command data associated with a pressed trigger may be associated with a greater maximum acceleration than the acceleration command data associated with an angled thumb stick. When the pilot fully presses the trigger on the first handle bar, the transmitted acceleration data may correspond to a maximum forward acceleration at which the multicopter may move. The trigger may correspond to only forward acceleration to encourage piloting the vehicle at high speeds only in the direction in which the pilot is facing.

A second handle bar may be configured to control altitude and braking. Responsive to the thumb stick being moved or the trigger being pressed, corresponding altitude control command data and braking command data may be transmitted to the computer, respectively. In embodiments, the second handle bar may be the right handle bar or the left handle bar.

The altitude control command data may correspond to an angle or direction at which the thumb stick on the second handle bar is pressed, and may also be proportional to the angle at which the thumb stick on the second handle bar is pressed. For example, moving the second thumb stick to the left may transmit vertical movement command data to the computer associated with an ascending acceleration, and moving the second thumb stick to the right may transmit vertical movement data to the computer associated with a descending acceleration. When the second thumb stick is pressed further to the right or to the left, the data may command a greater acceleration. Movements of the second thumb stick forward or backwards may not cause any movement command data to be transmitted.

In embodiments, the second thumb stick may include a spring or other zeroing mechanism to return the second thumb stick to the center of the left-right axis of the second thumb stick but may not include a spring in the up-down axis. In conventional multicopters, the spring-less axis is used to control altitude acceleration and it may be difficult to maintain a fixed vertical height. To alleviate strain on a pilot's focus, upon start-up of multicopter 100, a counter-acceleration to gravity to maintain multicopter 100 at a fixed height may be determined. A pilot may be able to specify this counter-acceleration by using the second joystick to determine an ascending acceleration that will result in multicopter 100 maintaining a constant altitude. Upon moving the second thumb stick to determine the counter acceleration of gravity, this counter-acceleration data may be transmitted and stored on the computer. Then, when the pilot lets go of the second thumb stick, the computer will maintain this counter-acceleration at the thumb stick neutral position to maintain constant altitude.

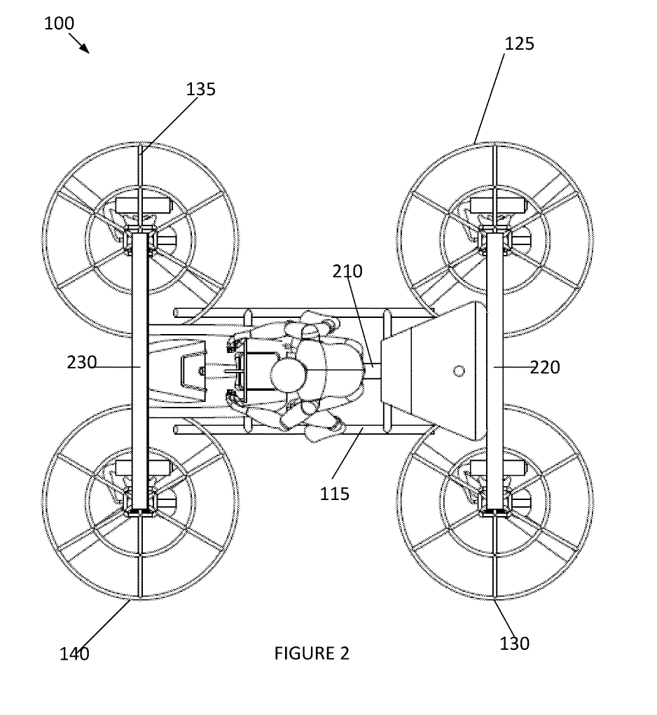

FIG. 2 depicts a top view of multicopter 100, according to an embodiment. Elements depicted in FIG. 2 may be substantially the same as those described above. Therefore, for the sake of brevity an additional description of these elements is omitted.

As depicted in FIG. 2, each of the propeller units 125, 130, 135, 140 may be set equidistance from a major axis of multicopter 100, with propeller units 125 and 130 being positioned behind the pilot and propeller units 135 and 140 being positioned in front of the pilot. In embodiments, a distance between propeller units 125 and 130 may be less than a distance between propeller units 125 and 135.

As additionally depicted in FIG. 2, the ends of landing rails 115 may be positioned between the second beam 220 and the third beam 230, wherein first beam 210 may be positioned between landing rails 115.

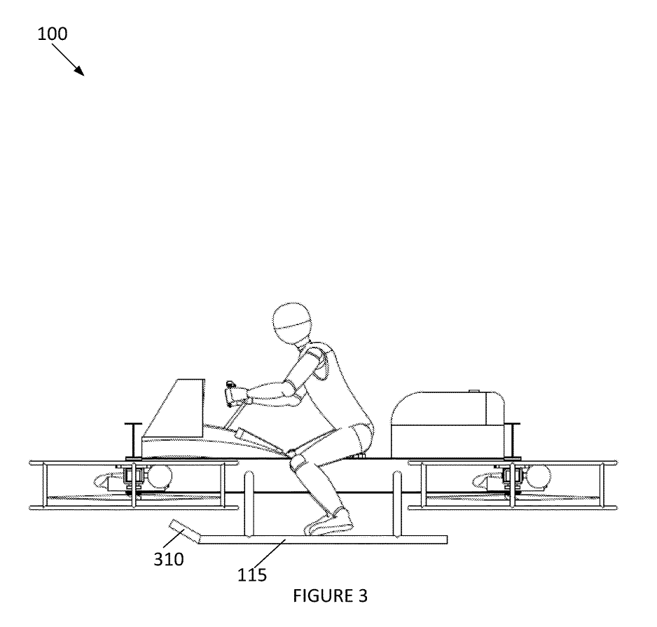

FIG. 3 depicts a side view of multicopter 100, according to an embodiment. Elements depicted in FIG. 3 may be substantially the same as those described above. Therefore, for the sake of brevity an additional description of these elements is omitted.

As depicted in FIG. 3, the ends of landing rails 115 may be positioned under the corresponding propeller units 125, 130, 135, 140. Additionally, a front end 310 of landing rails 115 may be angled at an incline. This may allow multicopter 100 to more safely takeoff and land.

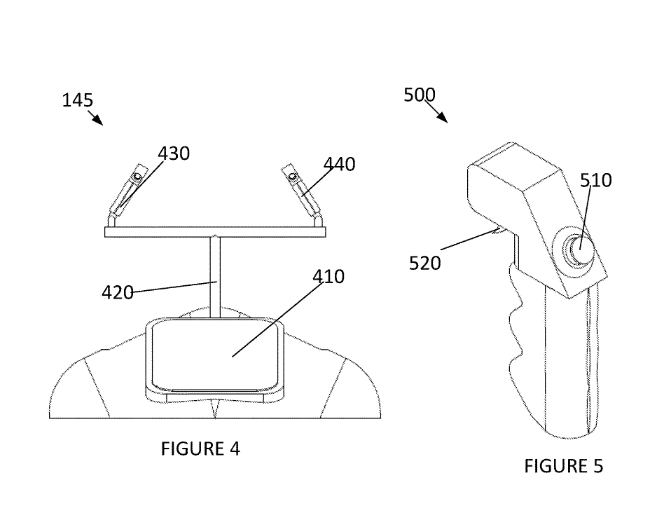

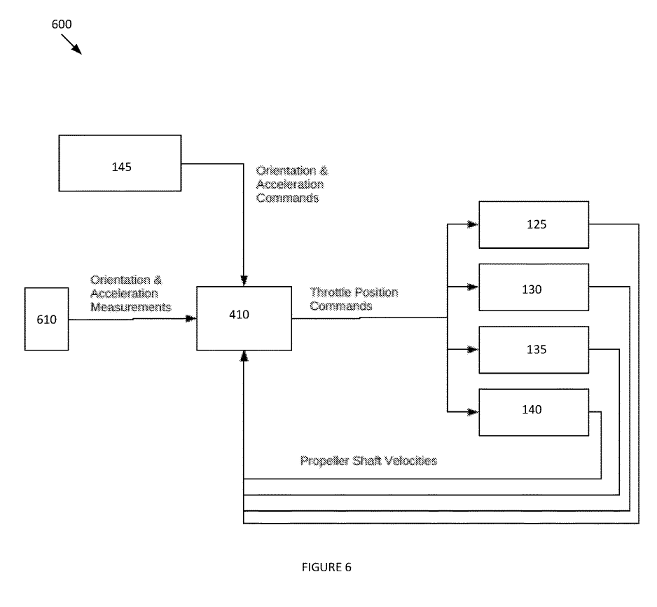

FIG. 4 depicts a front view of control interface 145, according to an embodiment. FIG. 5 depicts a perspective view of a handle bar 500, according to an embodiment. Elements depicted in FIGS. 4 and 5 may be substantially the same as those described above. Therefore, for the sake of brevity an additional description of these elements is omitted.

As depicted in FIG. 4, control interface 145 may include a computer 410, a steering column 420, a first handle bar 430, and a second handle bar 430.

Computer 410 may include a processing device, a communication device, a memory, and a graphical user interface. It may be understood that computer 410 may include a plurality of processing devices, communication devices, memories, and graphical user interfaces.

The processing devices can include memory, e.g., read only memory (ROM) and random access memory (RAM), storing processor-executable instructions and one or more processors that execute the processor-executable instructions. In embodiments where the processing device includes two or more processors, the processors may operate in a parallel or a distributed manner. The processing devices may execute an operating system of multicopter 100 or software associated with other elements of multicopter 100.

The communication device may be a device that allows computer 410 to communicate with other devices associated with multicopter 100, such as the embedded systems or position tracking system. The communication device may include one or more wireless transceivers for performing wireless communication and/or one or more communication ports for performing wired communication. The communication device may be utilized to communicate data to each of the propeller units to control the angular speed of each propeller based in part on the acceleration data and the vertical offset data.

The memory device may be a device configured to store data generated or received by computer 410. The memory device may include, but is not limited to a hard disc drive, an optical disc drive, and/or a flash memory drive.

The user interface may be a device that allows a user to interact with computer. While one user interface is shown, the term “user interface” may include, but is not limited to being, a touch screen, a physical keyboard, a mouse, a camera, a video camera, a microphone, and/or a speaker. Utilizing the user interface, a pilot may set data associated with multicopter 100, such as a counter-acceleration to gravity to maintain multicopter 100 at a fixed altitude.

Steering column 420 may be a device that is physically coupled to an electric motor, first handle bar 440 and second handle bar 430, and electronically connected to computer 410. Steering column 420 may be configured to transfer the pilots input torque to the electric motor. The electric motor may be configured to continuously provide gentle torque to reset steering column in a straight, upright position. This gentle torque from the electric motor may provide a haptic sensation of a torsional spring on steering column 420, such that steering column 420 returns to a zero offset if the pilot provides no force upon steering column 420.

Responsive to the steering column 420 being turned via first handle bar 440 and/or second handle bar 430, yaw data may be transmitted from the steering column 420 to the computer 410. The yaw data may include direction data and magnitude data associated with the yawing angular velocity that is proportional to the angular offset of first handle bar 440 and second handle bar 430. In embodiments, the greater the magnitude of the yawing, the greater the rate of rotation of multicopter 100.

First handle bar 440 and second handle bar 430 may be positioned at opposite sides of steering column 420. First handle bar 440 and second handle bar 430 may be inwardly angled. As depicted in FIG. 5, first handle bar 430, which is substantially symmetrical and interchangeable with second handle bar 430, may include a thumb stick 510 and a trigger 520. The thumb stick 510 may be tilted in different directions, and the trigger 520 may be depressed.

FIG. 6 depicts a network topology of the computing systems 600 of multicopter 100, according to an embodiment. Elements depicted in FIG. 6 may be substantially the same as those described above. Therefore, for the sake of brevity an additional description of these elements is omitted.

As depicted in FIG. 6, control interface 145 may be coupled with computer 410. The control interface 145 may be configured to transmit command data to control the movement of multicopter 110 via the propeller units 125, 130, 135, 140. The inertial measurement unit 610 (IMU) may be configured to determine specific accelerations, geo-directional data, angular velocities and orientation of multicopter 100. The data determined by inertial measurement unit 610 may be utilized to control the movement of multicopter 100.

Responsive to control computer receiving acceleration and yaw command data from control interface 145, control computer may dynamically determine the desired shaft speed of each propeller based on a control algorithm and a closed loop feedback control structure, which utilizes the yaw command data, acceleration command data, and measurements determined by the inertial measurement unit 610.

The propeller units 125, 130, 135, and 140 may be configured to receive data from the control computer to dynamically and independently change the rotation speed of each corresponding propellers. Tachometers associated with each of the propeller units 125, 130, 135, and 140 may be configured to transmit a determined angular velocity of each corresponding propeller to the control computer.

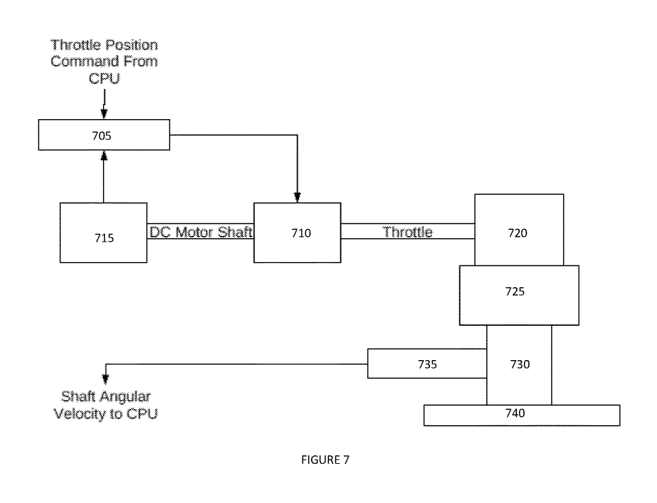

FIG. 7 depicts a propeller unit 125, according to an embodiment. One skilled in the art may appreciate that the other propeller units include similar elements. Elements depicted in FIG. 7 may be substantially the same as those described above. Therefore, for the sake of brevity an additional description of these elements is omitted.

As depicted in FIG. 7, propeller unit 125 may include a DC motor driver 705, DC motor 710, DC motor encoder 715, carburetor 720, engine 725, propeller shaft 730, tachometer 735, and propeller 740.

DC motor driver 705 may be a device that is configured to receive a throttle position command from computer 410. DC motor driver 705 may also be configured to receive position data of the DC motor 710 via DC motor encoder 715. Responsive to receiving the position data, DC motor driver 705 may be configured to determine an appropriate current to send to DC motor 710 to achieve a desired position.

DC motor 710 may be an electrical machine that converts direct current electrical power into mechanical power. DC motor 705 may be configured to receive the electrical power from DC motor driver 705, and in return create mechanical power.

DC motor encoder 715 may be a device that is configured to communicate the actual position of the throttle to DC motor driver 705. In embodiments, DC motor encoder 715 may be configured to transmit the angular position of the throttle to DC motor driver 705.

Carburetor 720 may be a device that blends air and fuel from the throttle for engine 725. Engine 725 may be an internal combustion engine where the combustion of fuel occurs with an oxidizer, such as air, in a combustion chamber. The amount of air received by engine 725 may be based on the current supplied to DC motor 705, wherein the amount of air received by engine determines the rotation speed of propeller shaft 730. Responsive to propeller shaft 730 rotating, propeller 740 may also rotate and tachometer 735 may determine the angular velocity of propeller shaft 730. Then, tachometer 735 may transmit the angular velocity of propeller shaft 730 to the control computer.

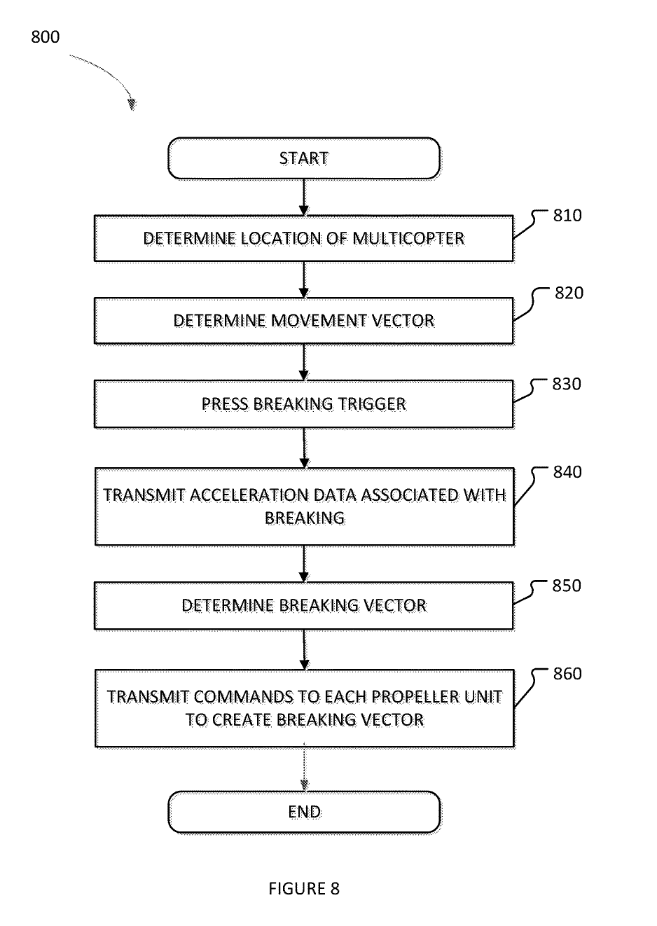

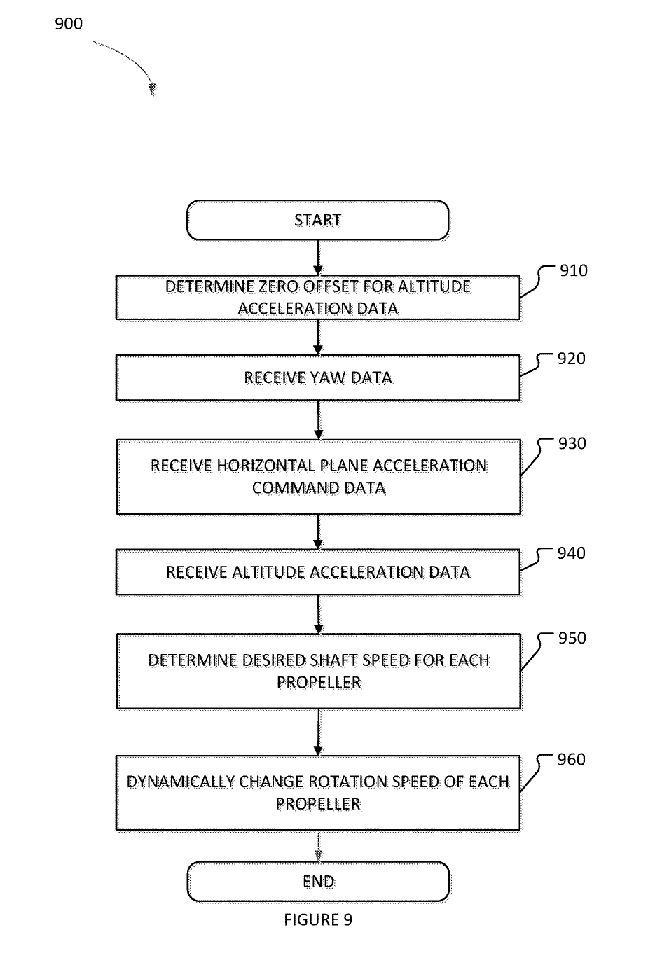

FIG. 8 illustrates a method 800 for multicopter 100 performing a braking operation or decelerating utilizing position tracking and computed vectors. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and are described below is not intended to be limiting.

In some embodiments, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At operation 810, a positioning system for determining the location of a multicopter in space may be implemented. The positioning system may include camera based localization systems that allow a computer to determine a multicopters spatial position and velocity vector. In other implementations, other positioning systems such as fiducial tracking motion capture systems or etc. may be utilized.

At operation 820, a movement vector associated with the directional movement and magnitude based on the speed of the multicopter may be determined.

At operation 830, a trigger associated with a second handle bar may be pressed, wherein the trigger corresponds to a braking operation.

At operation 840, acceleration command data associated with the braking operation may be transmitted from the control interface to the computer.

At operation 850, the computer may determine a braking vector. The braking vector is based on a vector opposite to the movement vector and the amount of the depression of the trigger. When the trigger is fully pressed, the magnitude of the deceleration vector commanded will be at a maximum safe deceleration vector determined by the control algorithms.

At operation 860, the computer may transmit commands to each of the propeller units to perform movements associated with the braking vector.

FIG. 9 illustrates a method 900 for controlling multicopter 100. The operations of method 900 presented below are intended to be illustrative. In some embodiments, method 900 may be accomplished with one or more additional operations not described, and/or without one or more of the operations discussed. Additionally, the order in which the operations of method 900 are illustrated in FIG. 9 and described below is not intended to be limiting.

In some embodiments, method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At operation 910, a zero offset for the altitude acceleration data may be determined. The zero offset for the altitude acceleration data may be equal to a counter acceleration of gravity on the multicopter to maintain the multicopter at a fixed vertical height.

At operation 920, yaw data may be received that is proportional to the angular offset of a first handle bar and a second handle bar. The yaw data may include direction data and magnitude data.

At operation 930, horizontal plane acceleration command data may be received. The horizontal plane acceleration data may be received responsive to a thumb stick on the first handle bar being moved or trigger being pressed, wherein the horizontal plane acceleration data may be utilized to move the multicopter along a horizontal plane.

At operation 940, altitude acceleration data may be received. The altitude acceleration data may be received responsive to a thumb stick on the second handle bar being moved, wherein the altitude acceleration angle is proportional to the angle at which the thumb stick on the second handle bar is pressed.

At operation 950, a desired shaft speed of each propeller may be determined based on a control algorithm and a closed loop feedback control structure, which utilizes the yaw command data, horizontal plane acceleration data, altitude acceleration data and measurements determined by an inertial measurement unit.

At operation 960, the angular velocity of each propeller may be changed independently from the other propellers.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention.

Although the invention has been described with respect to specific embodiments thereof, these embodiments are merely illustrative, and are thus not restrictive of the invention. The description herein of illustrated embodiments of the invention is not intended to be exhaustive or to limit the invention to the precise forms disclosed herein (in particular, the inclusion of any particular embodiment, feature, or function is not intended to limit the scope of the invention to such embodiment, feature, or function).

Rather, the description is intended to describe illustrative embodiments, features and functions in order to provide a person of ordinary skill in the art context to understand the invention without limiting the invention to any particularly described embodiment, feature, or function. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures. It will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment.

Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term or as used herein is generally intended to mean “and/or” unless otherwise indicated. As used herein, a term preceded by “a” or an (and the when antecedent basis is “a” or “an”) includes both singular and plural of such term (i.e., that the reference “a” or an clearly indicates only the singular or only the plural). Also, as used in the description herein, the meaning of in includes in and on unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A multicopter, comprising:
a frame including a first beam, a second beam, and a third beam, the second beam being positioned on a distal end of the first beam and the third being positioned on a proximal end of the first beam;
a control interface configured to control the positioning of the multicopter, the control interface including a steering column, a first handle bar, and a second handle bar, the steering column being configured to generate yaw command data, the first handle bar being configured to generate horizontal plane acceleration command data, and the second handle bar being configured to generate altitude acceleration command data and braking command data;
a plurality of propeller units, each of the propeller units including a combustion engine, a propeller configured to rotate, a tachometer, and a position controlled motor, each propeller on a corresponding propeller unit being configured to independently rotate;
a computer coupled with the control interface and each of the plurality of propeller units, the computer being configured to determine a desired rotational speed for each of the propellers based in part on the acceleration command data, measured acceleration and orientation from an inertial measurement unit and location data from a position tracking system.

2. The multicopter of claim 1, wherein the first handle bar includes a first thumb stick and a first trigger, wherein a direction associated with the horizontal plane acceleration command data is based on an angular position of the first thumb stick.

3. The multicopter of claim 2, wherein movement of the first thumb stick in a forward direction transmits fine forward acceleration command data to move the multicopter forward, movement of the first thumb stick in a backward direction transmits backward fine acceleration command data to slow down the multicopter, movement of the first thumb stick in a right direction transmits fine strafe right acceleration command data to move the multicopter in a right direction, and movement of the first thumb stick in a left direction transmits fine strafe left acceleration command data to move the multicopter in a left direction.

4. The multicopter of claim 3, wherein pressing the trigger transmits forward acceleration command data, wherein a maximum acceleration command is transmitted when pressing the trigger is greater than that of the horizontal plane acceleration command transmitted by moving the first thumb stick.

5. The multicopter of claim 1, wherein the second handle bar includes a second thumb stick and a second trigger, wherein a direction and magnitude associated with the altitude acceleration command data is based on an angular position of the second thumb stick.

6. The multicopter of claim 5, wherein the second thumb stick includes a device configured to return the second thumb stick to a center of a left-right axis, wherein when the second thumb stick is in the center of the left-right axis the multicopter is positioned at a fixed vertical height.

7. The multicopter of claim 1, wherein the steering column is positioned between the first handle bar and the second handle bar, and generates the yaw command data responsive to being rotated.

8. The multicopter of claim 7, wherein the steering column is coupled to a DC motor that continuously applies torque to the steering column to zero the steering column.

9. The multicopter of claim 1, wherein the tachometers associated with each propeller unit independently measure the rotational speed of a corresponding propeller.

10. The multicopter of claim 1, wherein the computer independently determines a desired throttle position of each propeller based on a control algorithm and a closed loop feedback loop with each of the tachometers.

11. The multicopter of claim 1, wherein a braking operation is performed responsive to pressing a trigger associated with the second handle bar.

12. The multicopter of claim 11, wherein the braking operation includes the computer determining a movement vector including a magnitude and a direction and determining a braking vector including an opposite direction of the movement vector, wherein a magnitude associated with the braking vector is a percentage of a maximum safe deceleration of the vehicle and said percentage is based on how far second trigger is pressed.

13. The multicopter of claim 12, wherein the computer transmits commands to each of the propellers to create the braking vector.
